(19) United States
(12) Patent Application Publication
(10) Pub. No.: US 2006/0037293 A1
(43) Pub. Date: Feb. 23, 2006

(54) Blast medium pot

(76) Inventors: Ron D. Storer, Brea, CA (US); Robert A. Robinson, Glenwood, NM (US)

Correspondence Address: STETINA BRUNDA GARRED & BRUCKER, 75 ENTERPRISE, SUITE 250, ALISO VIEJO, CA, 92656, US

(21) Appl. No.: 10/919,881

(22) Filed: Aug. 17, 2004

(51) Int. Cl. B01D 45/00; B01D 46/00; B01D 47/00; B01D 49/00; B01D 50/00; B01D 53/00; B01D 57/00; B01D 59/00

(52) U.S. Cl. 55/410

(57) ABSTRACT

Provided is a blast medium pot for a blast cabinet for delivering blast particulate. The blast medium pot includes a housing portion, a hollow pressure vessel, and a plunger assembly disposed therebetween. The pressure vessel has a blast inlet disposed at an upper end of the interior chamber and a compressed air inlet fluidly connected to a compressed air source for pressurizing the pressure vessel. The plunger assembly has a valve body located within the pressure vessel and is sized and configured such that direct engagement thereof against the blast inlet creates a fluid-tight seal. The plunger assembly is configured such that the valve body is selectively movable between open and closed positions wherein compressed air may be maintained within the pressure vessel when the valve body is in the closed position and blast particulate may pass through the blast inlet when the valve body is in the open position.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to blast cabinets and, more particularly, to a blast cabinet pressure vessel having a plunger assembly that is specifically adapted to bias the pressure vessel to a normally closed position such that the blast cabinet may be operated at a very low operating pressure.

Blast cabinets are typically utilized to prepare surfaces of a workpiece by directing high pressure fluid containing abrasive blast media or blast particulate toward the workpiece. The abrasive blast particulate is typically a relatively hard material such as sand, metallic shot or glass beads although many other types of materials such as water-soluble salts or sodium bicarbonate (i.e., baking soda) may be selected for use as the blast particulate. Selection of the type of blast particulate is generally dependent upon several factors inducing the purpose of the blasting to be performed as well as the type of workpiece to be blasted. In addition, the pressure level of the high pressure fluid may be adjusted to a limited extent depending upon the blasting application and the workpiece type.

For example, for applications involving surface texturing or stress relieving a workpiece that is fabricated of a hard material such as steel, a fairly aggressive blast particulate such as sand may be selected and the pressure at which the sand is directed onto the workpiece may be set at a relatively high level. Alternatively, for applications wherein the workpiece is relatively delicate or is fabricated from a relatively soft material, a relatively softer or less aggressive type of blast particulate such as sodium bicarbonate may be selected and the pressure at which the sodium bicarbonate is directed onto the workpiece may be set at a substantially lower level.

FIG. 1 illustrates a typical blast cabinet such as that which is commercially available from MEDIA BLAST & ABRASIVES, INC. of Brea, Calif. The blast cabinet typically includes a housing supported on legs. The housing defines a generally air tight enclosure having a pair of arm holes with gloves hermetically sealed thereto such that an operator may manipulate a blast hose and/or the workpiece for blasting thereof within the enclosure. The blast hose is configured to direct the high pressure fluid such as air mixed with the blast particulate at high velocity toward the workpiece surfaces. The blast cabinet typically includes a transparent window to allow the operator to manipulate the workpiece and to visually observe the progress of the blasting.

The blast particulate originates from a blast medium pot located immediately below the enclosure. The blast medium pot is typically shaped as an inverted cone or pyramid for funneling spent blast particulate downwardly towards a blast inlet located at a lower region of the blast medium pot. The blast medium pot includes a pressure vessel that is mounted directly below the blast medium pot for receiving the blast particulate from the blast medium pot. A plunger assembly is located at the blast inlet intermediate the blast medium pot and the pressure vessel. The plunger assembly is selectively moveable between an open position and a closed position for controlling the flow of spent blast particulate from the blast medium pot to the pressure vessel.

The plunger assembly is generally placed in the closed position during blasting in order to seal the pressure vessel such that it may be pressurized. When the plunger assembly is placed in the open position, spent blast particulate that has funneled downwardly in the blast medium pot may pass through the blast inlet, enter the pressure vessel, and fall to a lower region of the pressure vessel. The pressure vessel has a blast outlet at the lower region thereof for delivering the blast particulate to a mixing valve. The mixing valve controls the flow of the blast particulate from the pressure vessel to the blast hose such that a predetermined blast particulate/air mixture may be provided in substantially uniform manner to the blast hose. The blast hose is routed back up to the enclosure of the blast cabinet such that the blast particulate may be reused and directed toward the workpiece during blasting thereof. Mounted on a side of the pressure vessel is a compressed air inlet for receiving pressurized air from a compressed air source in order to pressurize the pressure vessel. The compressed air source also delivers pressurized air to the blast hose.

In many prior art blast cabinets, the pressurized air within the pressure vessel performs two primary functions. First, the pressurized air forces the blast particulate through the blast outlet and into the mixing valve. The blast particulate is subsequently mixed with a carrier fluid (i.e., compressed air) and is eventually ejected out of the blast hose at high velocity onto the workpiece located in the enclosure. Secondly, the pressurized air provides a biasing force that acts on the plunger assembly in order to move a hemispherically shaped mushroom valve or valve body of the plunger assembly upwardly into sealing engagement with the blast inlet.

The valve body is sized and configured to seal against the blast inlet. The valve body has a valve stem extending downwardly therefrom and which is slidably reciprocated within a sleeve that is mounted on a compressed air conduit disposed directly below the blast inlet. In order to pressurize the pressure vessel, a relatively loose fit is provided between the valve stem and the sleeve interior diameter within which the valve stem axially reciprocates. The compressed air conduit is fluidly connected to the compressed air inlet. The biasing force of the compressed air pushes on an underside of the valve body and overcomes the gravitational force of the valve body such that the valve body is moved to the closed position and the pressure vessel may be maintained in a pressurized condition. A portion of the compressed air escapes between the loose fit between the valve stem and the sleeve such that the pressure vessel may be simultaneously pressurized while the valve body is maintained in the closed position.

Unfortunately, plunger assemblies such as that described above suffer from several deficiencies that detract from their overall utility. For example, the compressed air entering the pressure vessel from the compressed air inlet must be supplied at a level that is sufficient to overcome the gravitational force (i.e., the weight) of the valve body such that the valve body may be pushed upwardly against the blast inlet in order to maintain the plunger assembly in the closed position. The air pressure level in relation to the plunger assembly results in a minimum pressure requirement within the pressure vessel of about twelve to about fifteen pounds per square inch (“psi”). Such a high pressure level is desirable for certain applications such as stress relieving a workpiece.

However, if the pressure level falls below this range, the gravitational force or weight of the valve body will exceed the biasing force applied thereto by the compressed air and the plunger assembly cannot be maintained in the closed position but rather will fall to the open position. In the open position, the effectiveness of the blast cabinet is compromised such that blasting cannot be performed as desired. Furthermore, the valve body of prior art blast cabinets is of a relatively large mass. Therefore, a relatively large amount of biasing force supplied by the compressed air is required in order to move the valve body into sealing engagement with the blast inlet. Unfortunately, the effectiveness of the compressed air biasing force is somewhat reduced due to loss of the portion of air pressure due to the relatively loose fit between the valve stem and the sleeve interior diameter within which the valve stem axially reciprocates.

Occasionally, it is desirable to utilize the blast cabinet to perform delicate blasting operations such as cleaning delicate workpieces including fine jewelry. Under such conditions, the compressed air must be provided at a reduced pressure level such that the blast particulate is ejected out of the blast hose at a relatively low velocity in order to avoid damaging such delicate workpieces. Accordingly, the pressure level of the compressed air within the pressure vessel is preferably reduced to about three psi. Unfortunately, under such a low pressure level, the compressed air is incapable of moving the valve body into sealing contact with the blast inlet under the gravitational force or weight of the valve body. Thus, the plunger assembly may not be maintained in the closed position and the pressure vessel cannot be pressurized. Failure to adequately pressurize the pressure vessel renders blasting operations ineffective.

Another deficiency associated with blast cabinets of the prior art is that blast particulate cannot flow into the pressure vessel during blasting operations. More specifically, the plunger assembly may only be moved from the closed position to the open position when the compressed air biasing force is removed and the pressure vessel is depressurized. Unfortunately, it may be necessary to replenish the supply of blast particulate in the pressure vessel during blasting operations. Unfortunately, blast particulate may only enter the pressure vessel when the compressed air biasing force is removed which results in a loss of pressurized air in the blast such that blasting operations are temporarily halted.

As can be seen, there exists a need in the art for a blast cabinet having the capability to maintain the plunger assembly in the closed position at low pressurization levels such as that required when blasting delicate workpieces at low pressurization levels. Additionally, there exists a need in the art for a plunger assembly for a blast cabinet wherein the plunger assembly may be readily moved between the closed and open position such that the pressure vessel may be easily refilled with blast particulate. Furthermore, there exists a need in the art for a plunger assembly for a blast cabinet wherein the plunger assembly may be moved to the open position during blasting operations such that the supply of blast particulate in the pressure vessel may be easily replenished. Finally, there exists a need in the art for a plunger assembly for a blast cabinet wherein the valve body may be of relatively low mass such that a reduced amount of biasing force is required to move the plunger assembly to the closed position.

### BRIEF SUMMARY OF THE INVENTION

The present invention specifically addresses and alleviates the above referenced deficiencies associated with blast cabinets of the prior art. More particularly, the present invention is an improved blast medium pot of a blast cabinet having a plunger assembly that may be autonomously maintained in the closed position such that blasting may be performed at low pressurization levels.

The blast medium pot may be comprised of a housing portion and a hollow pressure vessel with the plunger assembly being disposed intermediate or between the housing portion and the pressure vessel. The plunger assembly is moveable between the open and closed positions and uses a biasing member such as a spring to bias the plunger assembly to the closed position. The pressure vessel defines an interior chamber with a blast inlet, a compressed air inlet, and a blast outlet. The blast inlet is disposed at an upper end of the interior chamber and fluidly connects the housing portion to the interior chamber such that spent blast particulate may pass through the interior chamber of the pressure vessel when the plunger assembly is moved to the open position.

The compressed air inlet fluidly connects the interior chamber to a compressed air source for pressurizing the pressure vessel. The plunger assembly includes a valve body located within the pressure vessel below the blast inlet. The valve body has an outer surface which is sized and configured such that direct engagement thereof against the blast inlet creates a fluid-tight seal between the housing portion and the pressure vessel. The blast inlet may have an annular valve seat fabricated from resilient or elastomeric material such that direct engagement of the outer surface to the valve seat results in improved sealing of the interior chamber. The plunger assembly is selectively movable in a generally vertical direction between the open and closed positions such that compressed air may be maintained within the pressure vessel when the valve body is in the closed position and blast particulate may pass through the blast inlet when the valve body is in the open position.

The plunger assembly may comprise an elongate valve rod having an upper end and a lower end connected to the valve body. The valve rod extends upwardly through the blast inlet and into the housing portion. The plunger assembly may further comprise an actuator arm connected to the upper end of the valve rod. The actuator arm extends generally horizontally or laterally outwardly from the valve rod and may be pivotally connected thereto such as by a clevis joint. The actuator arm may preferably extend to an exterior of the housing portion such that an operator of the blasting cabinet may freely control movements of the plunger assembly between the open and closed positions.

The plunger assembly may further include a laterally extending pivot arm having a pivot end and a fixed end connected to the upper end of the valve rod with the pivot end being pivotally mounted on the housing portion. In this manner, lateral movement of the actuator arm may be translated into substantially vertical movement of the valve body in order to move the outer surface into and out of sealing engagement to the blast inlet or valve seat, if included. A biasing member, such as a tension spring, may be included with the plunger assembly and may extend between the upper end of the valve rod and the housing portion. The biasing member or tension spring is operative to bias the outer surface into sealing engagement with the valve seat such that the plunger assembly is normally oriented into the closed position.

### BRIEF DESCRIPTION OF THE DRAWINGS

These, as well as other features of the present invention, will become more apparent upon reference to the drawings wherein:

FIG. 1 is a perspective view of a blast cabinet having a blast medium pot disposed including a housing portion and a pressure vessel mounted below the housing portion;

FIG. 2 is an elevational view of a prior art plunger assembly disposed intermediate the housing portion and the pressure vessel and which is selectively moveable between closed and open positions and which utilizes compressed air to bias the plunger assembly to the closed position for sealing the pressure vessel prior to pressurization thereof;

FIG. 3 is an elevational view of a plunger assembly of the present invention in a first embodiment and which uses a spring to bias the plunger assembly to the closed position and wherein the compressed air is utilized to pressurize the pressure vessel;

FIG. 4 is an elevational view of a plunger assembly of the present invention in a second embodiment;

FIG. 5 is an elevational view of a plunger assembly of the present invention in a third embodiment; and

FIG. 6 is an elevational view of a plunger assembly of the present invention in a fourth embodiment.

### DETAILED DESCRIPTION OF THE INVENTION

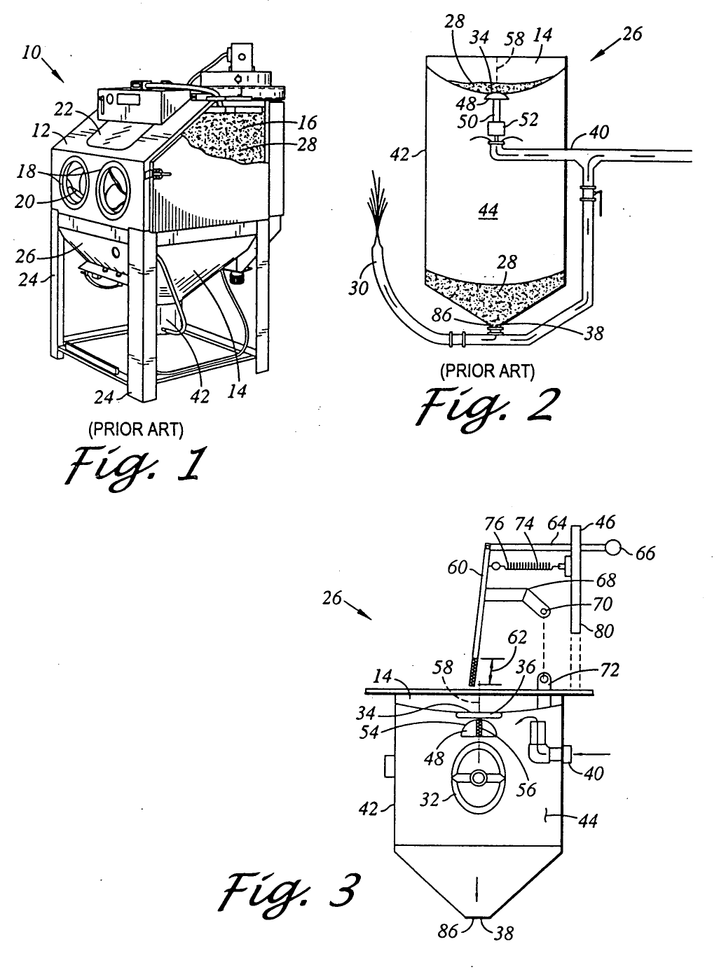

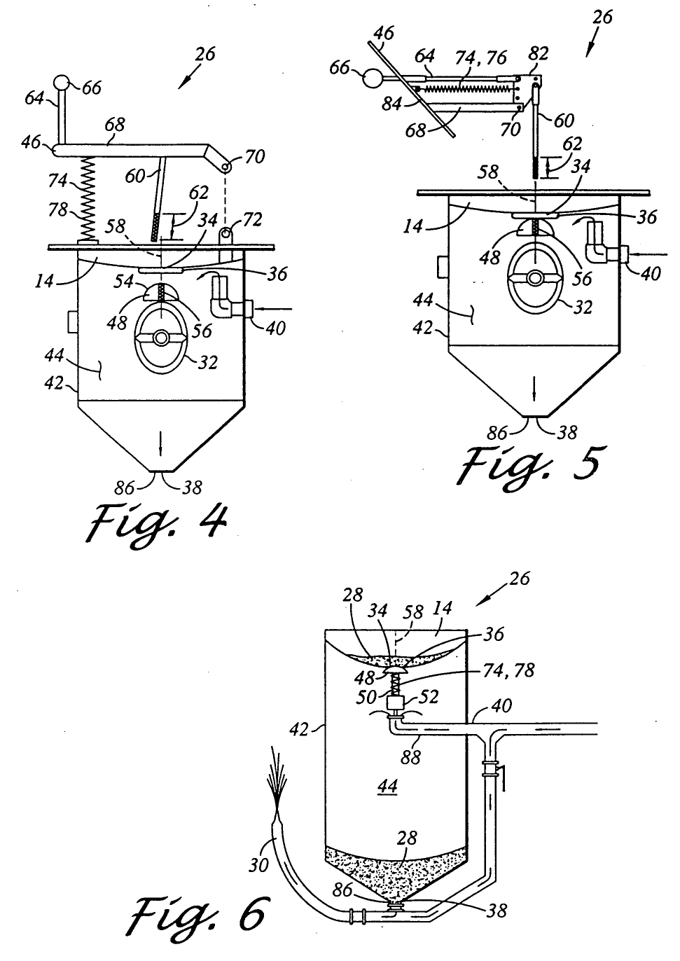

Referring now to the drawings wherein the showings are for purposes of illustrating the present invention and not for purposes of limiting the same, FIGS. 3, 4, 5 and 6 illustrate a plunger assembly 46 of the present invention in respective first, second, third and fourth embodiments as may be employed in a blast medium pot 26 of a blast cabinet 10 such as that shown in FIG. 1. The plunger assembly 46 advantageously includes the feature of being selectively moveable between a closed position and an open position. The plunger assembly illustrated in FIGS. 3, 5 and 6 are shown in the closed position. The plunger assembly shown in FIG. 4 is shown in the open position.

The blast cabinet 10 has a housing 12 which may be supported on legs 24, as shown in FIG. 1. The housing 12 defines a generally air tight enclosure 16 having a window 22 and a pair of arm holes 18 with gloves 20 hermetically sealed thereto such that an operator may view a workpiece (not shown) through the window 22 and manipulate a blast hose 30 and/or the workpiece for blasting thereof within the enclosure 16. The blast cabinet 10 is configured to blast the workpiece using pressurized air carrying abrasive blast particulate 28 through the blast hose 30. The blast particulate 28 is ejected out of the blast hose 30 at high pressure and/or high velocity in order to prepare surfaces of the workpiece. The blast medium pot 26 is disposed below the enclosure 16 and is configured to collect spent blast particulate 28 such that they may be recycled through the blast cabinet 10.

The blast medium pot 26 may be comprised of a housing portion 12 and a hollow pressure vessel 42. The housing portion 12 may have an inverted conical or pyramid shape for funneling the spent blast particulate 28 downwardly. The housing portion 12 is mounted below the housing 12 of the blast cabinet 10, as is shown in FIG. 1. The pressure vessel 42 is mounted below the housing portion 12. The plunger assembly 46 is disposed intermediate the housing portion 12 and the pressure vessel 42 and is moveable between the closed position and the open position, as was previously mentioned. The plunger assembly 46 uses a biasing member 74 to bias the plunger assembly 46 to the closed position such that compressed air may be utilized solely to pressurize the pressure vessel 42 during blasting operations.

Referring to FIG. 3, the pressure vessel 42 defines an interior chamber 44 with a blast inlet 34, a compressed air inlet 40, and a blast outlet 38. The blast inlet 34 is disposed at an upper end of the interior chamber 44 and defines a vertical axis 58. The blast inlet 34 also fluidly connects the housing portion 12 to the interior chamber 44 such that spent blast particulate 28 that accumulates at a bottom of the housing portion 12 may pass through the interior chamber 44 of the pressure vessel 42 when the plunger assembly 46 is moved to the open position. The compressed air inlet 40 fluidly connects the interior chamber 44 to a compressed air source for pressurizing the pressure vessel 42. The plunger assembly 46 includes a valve body 48 located within the pressure vessel 42 below the blast inlet 34.

The plunger assembly 46 is sized and configured such that direct engagement thereof against the blast inlet 34 creates a fluid-tight seal between the housing portion 12 and the pressure vessel 42. The valve body 48 has an outer surface 54 that may be configured in a rounded or hemispherical shape although the valve body 48 may be provided in a wide variety of alternative shapes and sizes. In addition, the blast inlet 34 may have an annular valve seat 36 disposed therearound with the outer surface 54 being sized and configured to be complementary to the valve seat 36. Preferably, the valve body 48 is configured to be complementary to the blast inlet 34 to facilitate sealing engagement thereto. Furthermore, the valve seat 36 may be fabricated from resilient or elastomeric material such that direct engagement of the outer surface 54 to the valve seat 36 results in improved sealing characteristics of the plunger assembly 46.

The plunger assembly 46 is configured such that the valve body 48 is selectively movable in a direction generally aligned with the vertical axis 58. The plunger assembly 46 is moveable between the open and closed positions such that compressed air may be maintained within the pressure vessel 42 when the valve body 48 is in the closed position and blast particulate 28 may pass through the blast inlet 34 when the valve body 48 is in the open position. Referring still to FIG. 3, the plunger assembly 46 of the first embodiment comprises an elongate valve rod 60 having an upper end and a lower end. The lower end of the valve rod 60 is connected to the valve body 48. The valve rod 60 extends upwardly through the blast inlet 34 and into the housing portion 12 such that the upper end of the valve rod 60 terminates in the housing portion 12.

The valve body 48 may optionally include a threaded valve bore 56 formed therein. The lower end of the valve rod 60 may have a threaded portion 62 formed thereon such that the valve rod 60 may be threadably engaged to the valve body 48. Access to the valve body 48 may be provided by including a hand hole 32 in the pressure vessel 42 as is shown in FIG. 3. If threadably engaged to the valve rod 60, inspection of the valve body 48 may be facilitated by simply removing a door covering the hand hole 32 and threadably removing the valve body 48 from the valve rod 60. As will be recognized, there are a wide variety of means for securing the valve body 48 to the valve rod 60. For example, the valve rod 60 may be provided as an unthreaded shaft inserted in a smooth bore of the valve body 48. A pair of cotter pins may be installed through the valve rod 60 on either of opposing sides of the valve body 48 for restricting axial movement of the valve body 48 relative to the valve rod 60. Alternatively, the valve body 48 may be permanently mounted on the valve rod 60 by welding or by any other suitable means.

Referring still to FIG. 3, the plunger assembly 46 may further comprise an actuator arm 64 connected to the upper end of the valve rod 60. The actuator arm 64 is affixed to the valve rod 60 at a location within the housing portion 12. The actuator arm 64 extends generally horizontally or laterally outwardly from the valve rod 60. A vertical plate 80 may optionally be included with the plunger assembly 46 and may be rigidly mounted on the housing portion 12 such as by welding, mechanical fasteners or any other suitable means. The vertical plate 80 may include an actuator arm 64 sleeve (not shown) formed therein and through which the actuator arm 64 may, in turn, axially slidably pass. The actuator arm 64 may be pivotally connected to the valve rod 60 by a clevis joint although the actuator arm 64 may be rigidly connected to the valve rod 60 such as by welding or by using mechanical fasteners.

The actuator arm 64 may preferably extend to an exterior of the housing portion 12 such that an operator of the blasting cabinet may freely control movements of the plunger assembly 46 between the open and closed positions. An actuator handle 66, shown configured in a spherical shape, may be disposed on an end of the actuator arm 64 to allow the operator to grip and manipulate the actuator arm 64. Many other configurations of the actuator handle 66 are contemplated. For example, the actuator handle 66 may be configured to ergonomically conform to the operator's hand by including finger recesses therein to provide a more comfortable means by which the operator may exert force on the actuator arm 64.

Referring still to FIG. 3, the plunger assembly 46 may include the valve rod 60 and may further include a laterally extending pivot arm 68 having a pivot end 70 and a fixed end. The pivot arm 68 may include an angled portion or an offset portion as shown in FIG. 3 in order to facilitate the motion of the valve body 48. The fixed end may be connected to the upper end of the valve rod 60 with the pivot end 70 being pivotally mounted on the housing portion 12 in spaced relation to or at a fixed distance from the blast inlet 34. Toward this end, at least one pivot lug 72 may be mounted on the housing portion 12 or on an upper portion of the pressure vessel 42 in spaced relation to the blast inlet 34.

The plunger assembly 46 may be configured such that the actuator arm 64 may be pivotally connected to the pivot lug 72. In this manner, the pivot arm 68 and, hence, the valve rod 60, may pivot about the pivot end 70 during movement of the actuator arm 64. Movement of the plunger assembly 46 between the closed and open positions may be facilitated by lateral movement of the actuator arm 64. Such lateral movement of the actuator arm 64 may be translated into substantially vertical movement of the valve body 48 in general alignment with the vertical axis 58 in order to move the outer surface 54 into and out of sealing engagement to the blast inlet 34 or valve seat 36, if included.

Importantly, a biasing member 74 may be included with the plunger assembly 46. The biasing member 74 may be configured as a tension spring 76 although other configurations of the biasing member 74 are contemplated. Regardless of its specific configuration, the biasing member 74 extends between the upper end of the valve rod 60 and the housing portion 12. If the plunger assembly 46 includes the vertical plate 80, the tension spring 76 may be connected thereto. The biasing member 74 or tension spring 76 is operative to bias the outer surface 54 into sealing engagement with the valve seat 36 such that the plunger assembly 46 is normally oriented into the closed position.

Referring now to FIG. 4, shown is the blast medium pot 26 in a second embodiment wherein the plunger assembly 46 includes the valve rod 60 and the actuator arm 64 is substantially vertically oriented such that the operator may regulate movement of the plunger assembly 46 between the open and closed positions by vertically moving the actuator arm 64. In the second embodiment, the fixed end of the pivot arm 68 is pivotally connected to or mounted on the housing portion 12 in spaced relation to the blast inlet 34 such as by means of the pivot lug 72, as was earlier described for the plunger assembly 46-of the first embodiment.

Likewise, the pivot arm 68 laterally extends outwardly from one side of the housing portion 12 over the blast inlet 34 to an opposite side of the housing portion 12. The pivot arm 68 may include the offset portion as shown in FIG. 3 in order to facilitate the motion of the valve body 48. The upper end of the valve rod 60 is joined to the pivot arm 68 at a point between the fixed end and the pivot end 70. For example, the valve rod 60 may be pivotally joined to the pivot arm 68 by means of a clevis and pin passing through the clevis and into the pivot arm 68. However, it is contemplated that the pivot arm 68 may be joined to the valve rod 60 in a variety of alternative means such as by welding and the like.

The actuator arm 64 is connected to the fixed end of the pivot arm 68 and extends generally vertically upwardly therefrom. Disposed on an end of the actuator arm 64 may be the actuator handle 66 as shown in the first embodiment of FIG. 3 and as was described above. The biasing member 74, illustrated in FIG. 4 as a compression spring 78, is captured between the pivot arm 68 and the housing portion 12 and is operative to bias the outer surface 54 into sealing engagement with the valve seat 36. More specifically, the biasing member 74 biases the pivot arm 68 away from the blast inlet 34 such that that valve rod 60 is moved or biased upwardly. Because the valve body 48 is attached to the valve rod 60, the valve rod 60 is biased into the closed position such that the pressure vessel 42 is normally sealed unless the plunger assembly 46 is manually opened by the operator. The plunger assembly 46 of the second embodiment is configured such that vertical movement of the actuator arm 64 causes the valve body 48 to move to the open position to allow blast particulate 28 to flow from the housing portion 12, through the blast inlet 34 and into the interior chamber 44 of the pressure vessel 42.

Referring now to FIG. 5, shown is the blast medium pot 26 of the third embodiment wherein the plunger assembly 46 includes the valve body 48 and valve rod 60 of the first and second embodiments and wherein the pivot arm 68 is mounted on the housing portion 12. Optionally, the pivot arm 68 may be mounted on an angle plate 84 which may, in turn, be mounted on the housing portion 12 such as with mechanical fasteners. If included, the angle plate 84 may preferably be oriented at an angle that is complementary to an angle of the housing portion 12. The pivot arm 68 extends laterally from the housing portion 12 or from the angle plate 84 in a manner similar to that shown in FIG. 3 and as was described above for the blast medium pot 26 of the first embodiment.

As shown in FIG. 5, a bellcrank or pivot plate 82 may be pivotally connected to the pivot end 70 of the pivot arm 68. Although shown as a generally triangular configuration, the pivot plate 82 may be configured in a wide variety of shapes and sizes sufficient to allow transfer of the actuator arm 64 motion to the valve rod 60. More specifically, the pivot plate 82 is configured to pivot about the pivot end 70 such that lateral motion of the actuator arm 64 may be translated into substantially vertical motion of the valve rod 60 and, ultimately, the valve body 48. The valve rod 60 is pivotally connected to the pivot plate 82 such as by means of a clevis and a pin although other means for connecting the valve rod 60 to the pivot plate 82 are contemplated.

The actuator arm 64 shown in FIG. 5 extends generally laterally outwardly from the pivot plate 82 and may pass through the pivot plate 82, if included, and the housing portion 12 so as to be exteriorly accessible. The angle plate 84 may include the actuator arm 64 sleeve formed therein and through which the actuator arm 64 may, in turn, axially slidably pass to the exterior of the housing portion 12 such that the operator may readily regulate the orientation of the plunger assembly 46. The biasing member 74, which may be configured as the tension spring 76 similar to that shown and described above for the first embodiment of FIG. 3, may extend between the pivot plate 82 and the housing portion 12. If the angle plate 84 is included, the biasing member 74 may extend between the pivot plate 82 and the angle plate 84.

Regardless of its manner of attachment, the biasing member 74 is operative to apply a rotational biasing force to the pivot plate 82 which is, in turn, connected to the valve rod 60 and which biases the outer surface 54 of the valve body 48 into sealing engagement with the blast inlet 34 or valve seat 36 such that the plunger assembly 46 is normally biased into the closed position. In this regard, the plunger assembly 46 of the third embodiment is configured such that lateral movement of the actuator arm 64 causes pivoting of the pivot plate 82 about the pivot end 70. Such pivoting of the pivot plate 82 is translated into substantially vertical motion of the valve rod 60 causing the valve body 48 to move between the open and closed positions.

Referring now to FIG. 6, shown is the blast medium pot 26 in a fourth embodiment wherein the valve body 48 has a valve stem 50 extending downwardly therefrom. Unlike the first, second and third embodiments, the plunger assembly 46 utilized in the blast medium pot 26 of the fourth embodiment lacks the valve rod 60, pivot arm 68 and actuator arm 64. Alternatively, the plunger assembly 46 employed in the blast medium pot 26 of the fourth embodiment utilizes a valve stem 50 that extends downwardly from the valve body 48 and which may be permanently fixed thereon or threadably engaged thereto. The plunger assembly 46 further includes a hollow, tubular sleeve 52 disposed under the blast inlet 34 and having a sleeve 52 bore (not shown) formed therein. The sleeve 52 bore is configured to axially slidably receive the valve stem 50 bore therein. Access to the valve body 48 and valve stem 50 may be facilitated by including the hand hole 32 in the pressure vessel 42.

The plunger assembly 46 further includes a compressed air conduit 88 extending generally laterally from the compressed air inlet 40 to the sleeve 52. As shown in FIG. 6, the compressed air conduit 88 is upwardly turned with the sleeve 52 mounted thereon and fluidly connecting the compressed air inlet 40 to the sleeve 52. In this manner, the compressed air conduit 88 provides an upwardly directed compressed air biasing force on the valve body 48 during pressurization of the pressure vessel 42. The valve body 48 may have a concave interior surface opposite the outer surface 54 to facilitate upward movement of the valve body 48 under the compressed air biasing force acting thereagainst.

The compression spring 78 is coaxially mounted on the valve stem 50 and is captured between the valve body 48 and the sleeve 52. The compression spring 78 is preferably sized and configured for providing an upwardly directed spring biasing force on the valve body 48 such that the spring biasing force and the compressed air biasing force collectively and autonomously move the valve body 48 to the closed position during pressurization of the pressure vessel 42. As was mentioned above regarding the second, third, and fourth embodiments of the blast medium pot 26, the blast inlet 34 of the blast medium pot 26 of the fourth embodiment may include the valve seat 36 which may be sized and configured to be complementary to the outer surface 54 of the valve body 48 for sealing engagement therebetween. Advantageously, the biasing member 74 of the blast medium pot 26 of the fourth embodiment may be retrofitted to prior art blast cabinets such as that shown in FIG. 2.

The operation of the blast medium pot 26 of the first, second and third embodiments will now be described with initial reference to FIGS. 3-5, respectively. It is generally desirable that the plunger assembly 46 is placed in the closed position during blasting in order to seal the pressure vessel 42 such that it may be pressurized. In the first and third embodiments of the blast medium pot 26 respectively shown in FIGS. 3 and 5, the biasing member 74 thereof, configurable as a tension spring 76, applies a constant upwardly directed spring biasing force on the valve rod 60 which, in turn, causes the valve body 48 to move upwardly into direct engagement with the blast inlet 34 or valve seat 36, if included. Once the valve body 48 is engaged to the blast inlet 34, the interior chamber 44 may be pressurized such that blast particulate 28 accumulated at the blast outlet 38 of the pressure vessel 42 may flow into a mixing valve 86 disposed below the blast outlet 38.

The mixing valve 86 controls the flow of the blast particulate 28 from the pressure vessel 42 to the blast hose 30. The compressed air inlet 40, mounted on a side of the pressure vessel 42, receives pressurized air from a compressed air source in order to pressurize the pressure vessel 42. The blast hose 30 is connected to the compressed air source to receive pressurized air therefrom. The blast hose 30 is fluidly connected to the mixing valve 86 and is routed up to the enclosure 16 of the blast cabinet 10. The mixing valve 86 controls the flow of the blast particulate 28 from the pressure vessel 42 to the blast hose 30 wherein a predetermined blast particulate 28/air mixture may be provided in substantially uniform manner to the blast hose 30 such that the blast particulate 28 may be uniformly directed toward the workpiece during blasting thereof. Spent blast particulate 28 funnels downwardly toward and accumulates adjacent the blast inlet 34 while the plunger assembly 46 is maintained in the closed position.

When the accumulation of blast particulate 28 within the pressure vessel 42 is reduced to a predetermined level, it may be desirable to move the plunger assembly 46 to the open position such that the spent blast particulate 28 may pass through the blast inlet 34, enter the pressure vessel 42, and fall toward and accumulate adjacent the blast outlet 38. In order to move the plunger assembly 46 to the open position, lateral force may be manually applied to the actuator arm 64 of FIGS. 3 and 5 in an amount sufficient to move the actuator arm 64 laterally inwardly such as in a direction away from the operator of the blast cabinet 10. Such lateral movement is translated into vertically downward movement of the valve rod 60 and, hence, the valve body 48 to disengage the outer surface 54 from the blast inlet 34 such that the plunger assembly 46 is move to the open position.

In the open position, accumulations of blast particulate 28 may then pass through the blast inlet 34 and enter the interior chamber 44 of the pressure vessel 42 where they may then fall downwardly toward the blast outlet 38. The mixing valve 86 controls the flow of the blast particulate 28 into the blast hose 30 for eventual reuse in the blast cabinet 10 enclosure 16. In this manner, the compressed air may be provided at a reduced pressure level such that the blast particulate 28 is ejected out of the blast hose 30 at a relatively low velocity in order to avoid damaging delicate workpieces such as, for example, fine jewelry

In order to move the plunger assembly 46 to the open position, vertical force may be applied to the actuator arm 64 of FIG. 4 in an amount sufficient to effectuate vertically downward movement of the valve rod 60 and, hence, the valve body 48 in order to disengage the outer surface 54 from the blast inlet 34. In this manner, the plunger assembly 46 is moved to the open position. Movement of the plunger assembly 46 from the open position to the closed position may be effected by removing the lateral and vertical forces on the actuator arm 64 of the plunger assembly 46 such that the spring biasing force of the biasing member 74 may move the valve body 48 back into sealing engagement with the blast inlet 34 or valve seat 36.

Referring to the operation of the blast medium pot of the fourth embodiment illustrated in FIG. 6, the plunger assembly 46 is normally maintained in the open position. In this regard, the spring biasing force acting alone is insufficient to overcome the gravitational force (i.e., the weight) of the valve body 48 such that the valve body 48 may be pushed upwardly against the blast inlet 34 or valve seat 36 in order to maintain the plunger assembly 46 in the closed position. However, when the compressed air enters the pressure vessel 42 from the compressed air inlet 40, the upwardly directed compressed air biasing force is applied to the valve body 48 which, when combined with the spring biasing force, is sufficient to overcome the gravitational force of the valve body. 48 such that the valve body 48 may be pushed upwardly against the blast inlet 34 and the plunger assembly 46 is moved to closed position. Such sealing engagement of the valve body 48 to the blast inlet 34 allows for pressurization of the pressure vessel 42 such that blasting operations may be effected.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A blast medium pot of a blast cabinet for delivering blast particulate, the blast medium pot comprising:
a housing portion;
a hollow pressure vessel mounted to the housing portion therebelow and defining an interior chamber with a blast inlet and a compressed air inlet, the blast inlet being disposed at an upper end of the interior chamber and defining a vertical axis, the compressed air inlet fluidly connecting the interior chamber to a compressed air source for pressurizing the pressure vessel; and
a plunger assembly disposed intermediate the housing portion and the pressure vessel, the plunger assembly having a valve body located within the pressure vessel and being sized and configured such that direct engagement thereof against the blast inlet creates a fluid-tight seal;
wherein the plunger assembly is configured such that the valve body is selectively movable along the vertical axis between open and closed positions such that compressed air may be maintained within the pressure vessel when the valve body is in the closed position and blast particulate may pass through the blast inlet when the valve body is in the open position.

2. The blast medium pot of claim 1 wherein:
the valve body has an outer surface of hemispherical shape;
the blast inlet has an annular valve seat disposed therearound;
the outer surface being sized and configured to be complementary to the valve seat for sealing engagement thereto.

3. The blast medium pot of claim 2 wherein the valve seat is fabricated of elast4omeric material.

4. The blast medium pot of claim 2 wherein the plunger assembly comprises an elongate valve rod having an upper end and a lower end connected to the valve body, the valve rod extending upwardly through the blast inlet and into the housing portion.

5. The blast medium pot of claim 4 wherein:
the valve body includes a threaded valve bore formed therein;
the lower end includes a threaded portion for threadable engagement to the valve body.

6. [FIG. 3] The blast medium pot of claim 4 wherein the plunger assembly comprises:
an actuator arm connected to the upper end of the valve rod and extending generally laterally outwardly therefrom;
a laterally extending pivot arm having a pivot end and a fixed end, the fixed end being connected to the upper end of the valve rod, the pivot end being pivotally mounted on the housing portion in spaced relation to the blast inlet such that the actuator arm may pivot about the pivot end; and
a biasing member extending between the upper end of the valve rod and the housing portion and being operative to bias the outer surface into sealing engagement with the valve seat;
wherein the plunger assembly is configured such that lateral movement of the actuator arm causes the valve body to move between the open and closed positions.

7. The blast medium pot of claim 6 wherein the biasing member is a tension spring.

8. The blast medium pot of claim 6 wherein the actuator arm extends to an exterior of the housing portion.

9. [FIG. 4] The blast medium pot of claim 4 wherein the plunger assembly comprises:
a pivot arm having a fixed end and a pivot end pivotally mounted on the housing portion in spaced relation to the blast inlet and laterally extending outwardly from the housing portion, the pivot arm and being connected to the upper end of the valve rod between the fixed and pivot ends;
an actuator arm connected to the fixed end of the pivot arm and extending generally vertically upwardly therefrom; and
a biasing member extending between the pivot arm and the housing portion and being operative to bias the outer surface into sealing engagement with the valve seat;
wherein the plunger assembly is configured such that vertical movement of the actuator arm causes the valve body to move between the open and closed positions.

10. The blast medium pot of claim 9 wherein the biasing member is a compression spring.

11. [FIG. 5] The blast medium pot of claim 4 wherein the plunger assembly comprises:
a pivot arm having a fixed end and a pivot end, the fixed end being mounted on the housing portion with the pivot arm extending laterally therefrom;
a pivot plate being pivotally connected to the pivot end for pivoting thereabout, the valve rod being pivotally connected to the pivot plate;
an actuator arm pivotally connected to the pivot plate and extending generally laterally outwardly therefrom; and
a biasing member extending between the pivot plate and the housing portion and being operative to bias the outer surface into sealing engagement with the valve seat;
wherein the plunger assembly is configured such that lateral movement of the actuator arm causes pivoting of the pivot plate about the pivot end and substantially vertical motion of the valve rod causing the valve body to move between the open and closed positions.

12. The blast medium pot of claim 11 wherein the biasing member is a tension spring.

13. The blast medium pot of claim 11 wherein the actuator arm extends to an exterior of the-housing portion.

14. [FIG. 6] The blast medium pot of claim 1 wherein the valve body has a valve stem extending downwardly therefrom, the plunger assembly further comprising:
a sleeve disposed under the blast inlet and having a bore for axially slidably receiving the valve stem bore therein;
a compressed air conduit having the sleeve mounted thereon and fluidly connecting the compressed air inlet to the sleeve for providing an upwardly directed compressed air biasing force on the valve body during pressurization of the pressure vessel;
a compression spring coaxially mounted on the valve stem and captured between the valve body and the sleeve for providing an upwardly directed spring biasing force on the valve body;
wherein the compression spring is sized and configured such that the spring biasing force and the compressed air biasing force collectively move the valve body to the closed position during pressurization of the pressure vessel.

15. The blast medium pot of claim 14 wherein:
the valve body has an outer surface of hemispherical shape;
the blast inlet has an annular valve seat disposed therearound;
the outer surface being sized and configured to be complementary to the valve seat for sealing engagement thereto.

16. The blast medium pot of claim 15 wherein the valve seat is fabricated of elastomeric material.

17. A blast cabinet having a blast medium pot, the blast cabinet having a housing defining an enclosure and being configured for blasting with blast particulate a workpiece disposed within the enclosure, the blast medium pot being disposed below the enclosure and configured to collect spent blast particulate, the blast medium pot comprising:
a housing portion;
a hollow pressure vessel mounted to the housing portion therebelow and defining an interior chamber with a blast inlet and a compressed air inlet, the blast inlet being disposed at an upper end of the interior chamber and defining a vertical axis, the compressed air inlet fluidly connecting the interior chamber to a compressed air source for pressurizing the pressure vessel; and
a plunger assembly disposed intermediate the housing portion and the pressure vessel, the plunger assembly having a valve body located within the pressure vessel and being sized and configured such that direct engagement thereof against the blast inlet creates a fluid-tight seal;
wherein the plunger assembly is configured such that the valve body is selectively movable along the vertical axis between open and closed positions such that compressed air may be maintained within the pressure vessel when the valve body is in the closed position and blast particulate may pass through the blast inlet when the valve body is in the open position.

18. The blast medium pot of claim 17 wherein:
the valve body has an outer surface of hemispherical shape;
the blast inlet has an annular valve seat disposed therearound;
the outer surface being sized and configured to be complementary to the valve seat for sealing engagement thereto.

19. The blast medium pot of claim 18 wherein the valve seat is fabricated of elastomeric material.

20. The blast medium pot of claim 18 wherein the plunger assembly comprises an elongate valve rod having an upper end and a lower end fixedly connected to the valve body, the valve rod extending upwardly through the blast inlet and into the housing portion.

21. The blast medium pot of claim 20 wherein:
the valve body includes a threaded valve bore formed therein;
the lower end includes a threaded portion for threadable engagement to the valve body.

22. The blast medium pot of claim 20 wherein the plunger assembly comprises:
an actuator arm pivotally connected to the upper end of the valve rod and extending generally laterally outwardly therefrom;
a laterally extending pivot arm having a pivot end and a fixed end, the fixed end being connected to the upper end of the valve rod, the pivot end being pivotally mounted on the housing portion in spaced relation to the blast inlet such that the actuator arm may pivot about the pivot end; and
a biasing member extending between the upper end of the valve rod and the housing portion and being operative to bias the outer surface into sealing engagement with the valve seat;
wherein the plunger assembly is configured such that lateral movement of the actuator arm causes the valve body to move between the open and closed positions.

23. The blast medium pot of claim 22 wherein the biasing member is a tension spring.

24. The blast medium pot of claim 22 wherein the actuator arm extends to an exterior of the housing portion.
